(19) United States
(12) Patent Application Publication
(10) Pub. No.: US 2008/0226281 A1
(43) Pub. Date: Sep. 18, 2008

(54) Business system for three-dimensional snapshots

(75) Inventor: Lenny Lipton, Los Angeles, CA (US)

Correspondence Address: REAL D - Patent Department, by Baker & McKenzie LLP, 2001 Ross Avenue, Suite 2300, Dallas, TX, 75201, US

(73) Assignee: Real D

(21) Appl. No.: 11/717,355

(22) Filed: Mar. 13, 2007

(51) Int. Cl. G03B 35/00

(52) U.S. Cl. 396/324

(57) ABSTRACT

A method for enabling viewing of stereoscopic images is provided. The method includes generating a stereo pair of images in digital form using at least one image recording device configured to produce two digital images producing a stereo pair. The method further includes offering the user an ability to provide the stereo pair of images to a display facilitator, the display facilitator comprising an ability to elect display from at least one from a group comprising a service bureau, a device configured to print the stereoscopic image, and a device configured to display the stereoscopic image. The user has an ability to choose a display facilitator for receiving the stereoscopic image and further has an ability to view at least one stereoscopic image resulting from the generating.

### BACKGROUND OF THE INVENTION

1. Field of the Invention

The present invention relates generally to the art of three-dimensional snapshot or still digital photographic picture taking, along with an infrastructure that can be used for displaying various image formats. More specifically, stereo pair information that has been captured can be reformatted to various viable viewing modalities such as hardcopy, or for viewing on an electronic display, either with eyewear selection devices or autostereoscopically.

2. Description of the Related Art

Digital photographic technology continues to make inroads into today's photographic marketplace with consumers enjoying its ease, and low cost, due in part to the absence of a need for film or film processing, and the ability to readily transfer digital images between digital devices, such as cell phones, PDAs, computers, TV screens, to share images electronically by means of the Internet, and so forth.

However, stereoscopic digital photography for use by amateur photographers does not now exist. No currently available commercial system enables a user to either take or view stereoscopic digital photographs or images. Further, current technology for enabling a user to view stereoscopic digital still images does not include the ability for the user to select amongst various stereoscopic viewing modalities such as hardcopy, or on an electronic display screen, using either active or passive eyewear or even autostereoscopically (without eyewear).

Current consumers would undoubtedly enjoy being able to take three dimensional digital images together with the ability to view such images on a variety of media and/or devices. It is therefore advantageous to offer simple, flexible, practical, and potentially low cost digital stereoscopic image viewing arrangements and infrastructure, including an ability to view such digital stereoscopic images using various modalities. Moreover, photography is the world's most popular hobby making the lack of a digital stereoscopic commercial infrastructure all the more apparent.

### SUMMARY OF THE INVENTION

According to one aspect of the present design, there is provided a method for enabling viewing of stereoscopic images. The method includes generating a stereo pair of images in digital form using at least one image recording device configured to produce two digital images producing a stereo pair. The method further includes offering the user an ability to provide the stereo pair of images to a display facilitator, the display facilitator comprising an ability to elect display from at least one from a group comprising a service bureau, a device configured to print the stereoscopic image, and a device configured to display the stereoscopic image. The display facilitator may facilitate display using electronic or hardcopy means. The user has an ability to choose a display facilitator for receiving the stereoscopic image and further has an ability to view at least one stereoscopic image resulting from the generating.

The user has the ability to self-facilitate by displaying the stereoscopic image using a PC or similar device via his display screen or using a printer to produce paper or similar hardcopy prints. In addition, traditional planar displays or prints may also be produced and viewed.

These and other advantages of the present invention will become apparent to those skilled in the art from the following detailed description of the invention and the accompanying drawings.

### BRIEF DESCRIPTION OF THE DRAWINGS

The present invention is illustrated by way of example, and not by way of limitation, in the figures of the accompanying drawings in which:

FIG. 1 is a diagram of a generic stereo pair camera and a sample subject;

FIG. 2 is a flow chart showing the digital stereoscopic system infrastructure; and

FIG. 3 illustrates an embodiment of one implementation of the current design, specifically including providing a stereo pair to a display facilitator such as a software program.

### DETAILED DESCRIPTION OF THE INVENTION

The present design includes an infrastructure beginning with a camera employed to capture stereo pairs, and a design to process these images so that they can be viewed on a personal computer (PC) screen or other electronic display screen, or alternately, as hardcopy. The intended user can lack sophisticated technical skills, and the system takes such abilities or limitations into account. The infrastructure system is flexible insofar as it allows the user to make choices with regard to the degree of creative effort required in facilitating creation of an image and in whose hands that effort shall be entrusted. That is to say, the user decides whether display of the stereoscopic image is in the user's hands or in the hands of a service bureau. This methodology is in accordance with traditional approach to photography and snapshot taking and snapshot viewing that has evolved over more than a century.

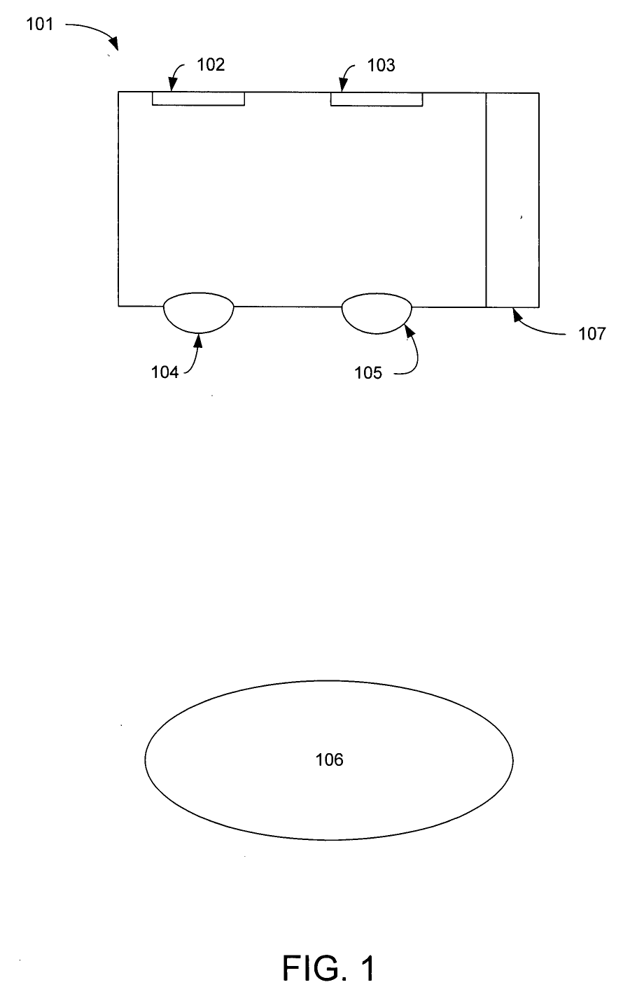

FIG. 1 is a schematic representation of a stereoscopic still digital camera and subject to be photographed from the top looking down as a cross-sectional schematic view. Camera 101 has left and right imaging lenses 104 and 105. Image sensor 102 is related to lens 104 and image sensor 103 is related to lens 105. Processing electronics 107 are shown as a block. The images captured at image sensors 102 and 103 are processed by electronics or circuit 107. Object 106 is a representative object in the field of view of the camera. The result of taking a digital photograph with the setup of FIG. 1 is that two separate digital images are created, one offset from the other. The result is a left image file and a right image file. It will also be understood that these two separate images can be combined into one file for convenience, as for example in the JPEG variant that has been in use by stereographers for some years known as the JPS format.

Either the left or the right image file can be viewed as a planar image by well-known means on a monitor or television set, or can be printed by the end user on a home inkjet or similar printer, or can be sent to a service bureau and be handled as a normal planar photographic print. Such flexibility in terms of display presentation would be desirable for stereoscopic images and is primary subject matter of this design. The present design uses the left and right image as inputs and enables the user to view a stereoscopic image in a number of ways according to the present design.

As used herein, the term “service bureau” is intended to be construed broadly, but is generally understood to those skilled in the photographic image arts as an entity that provides services that may be beyond the capabilities of a typical user or to provide such services because they are more conveniently provide by a specialist entity. Such a service bureau can perform a variety of tasks, including but not limited to producing transparencies, prints, or negatives, scanning in high resolution color or black and white, image editing, and ultimately producing a viewable image in a desired format. Service bureaus are known by many names, including “digital imaging center” or “process shop” As used herein, the term “service bureau” generally follows this definition but may include other related entities. These days digital files may be transmitted to the service bureau, by means of the internet for example, and the bureau may provide a variety of functions such as print making, producing hardcopy or softcopy albums, calendars, and the like. Or they may provide a depository for files to be shared with clients, friends, and relatives.

Once received or taken, the two images may be processed two related files, or as noted above, as a single file such as a file in the JPS file format. That is to say, the files for the left and right images captured by the sensors 102 and 103 and processed by electronics 107 may be handled separately or conjoined into a single-file format incorporating both left and right image information.

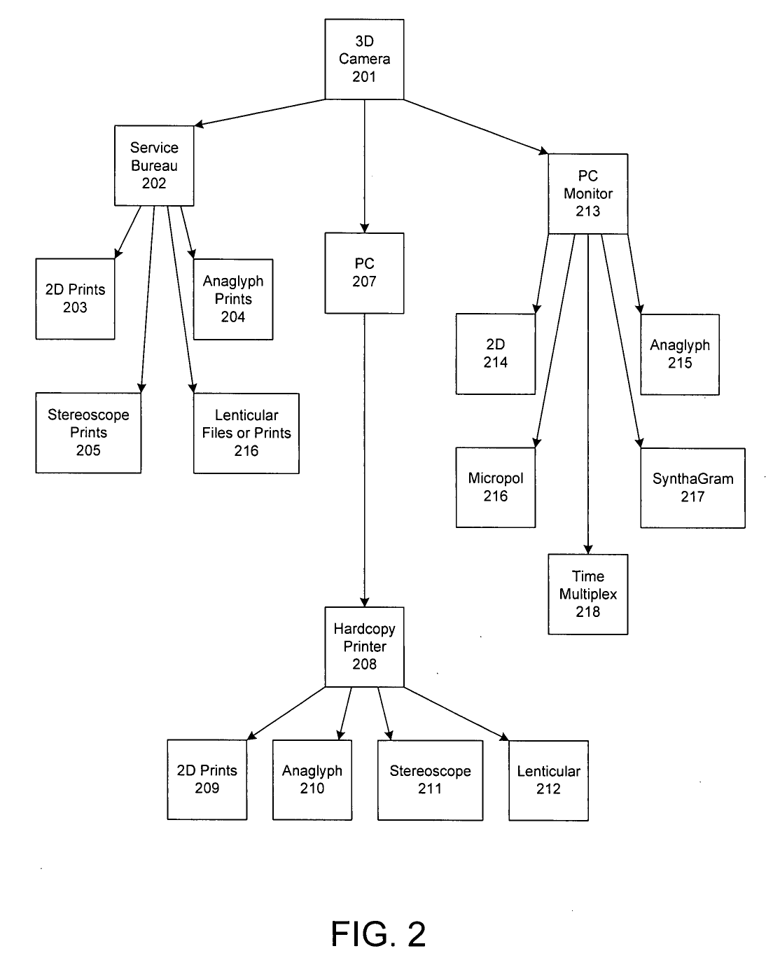

The illustration of FIG. 1 is intended to be a generalized depiction of a device that can take digital stereoscopic photographs, and construction of such a device is known to those skilled in the art. The key to the depiction of FIG. 1 is that two digital images are obtained simultaneously at different perspectives of the subject 106. Such receipt of two digital images may alternately be accomplished by various devices or cameras, including but not limited to two cameras positioned adjacent one another and connected such that images are taken simultaneously, two cameras where the users take pictures simultaneously, a camera arrangement where a single camera body houses two or more inputs, such as two or more lenses, where at least one lens can be moved within the body, such as horizontally. Moving picture cameras or devices could be employed, again in the form of one device with two inputs or two separate devices. Again, these are devices that could be employed to accomplish the fundamental objective of obtaining two digital images that can be combined to form a stereoscopic image, and the form this front-end photographic device is not critical to the invention disclosed herein. What is key is the two digital images being available and provided to the design of FIG. 2.

The first stereoscopic images were photographed in 1839 and subsequently there have been a vast number of designs and products offered up and including the present day and this disclosure does not seek to place limitations on the origination of the stereo-pairs but rather seeks to embrace all such cameras and techniques for producing such content.

FIG. 2 illustrates the infrastructure of the system that is central to the current design. Three branches originate from the capture of the image by camera 201, where camera 201 corresponds to the camera 101 of FIG. 1 or similar device. These branches flow to three paths: files delivered to a service bureau 202, to a PC 207 for hardcopy means, and to direct viewing on a PC monitor 213.

The first branch is the service bureau approach for obtaining prints or files. The files captured by the camera are sent to the service bureau—uploaded by means of the Internet, sent by mail, or brought to the camera shop or similar location offering facilitation services. The service bureau then processes the files to produce conventional 2-D prints 203, or an anaglyph print 204. Software is provided to service bureau so that the left and right images may be turned into monochrome or color anaglyph prints and then presented in hardcopy form to be viewed with red-green or red-blue glasses.

Another alternative is for the service bureau to produce stereoscopic prints 205 in the form of stereo pairs that can be viewed in a stereoscope. The stereoscope is a well-known device employing two lenses (or sometimes prism or mirrors), each lens devoted to one perspective view. The print may be placed in a holder and then viewed through the stereoscope lenses. The print can also be turned into photographic slides that can be viewed in a stereoscopic slide viewer (stereoscope) such as the ubiquitous ViewMaster device.

Yet another option is for the service bureau to produce a lenticular autostereoscopic print or files 206. Such an image is also known as a parallax panoramagram or more simply just as a panoramagram. Interpolation algorithms, many of which are well known, can be used to create the intermediate views that lie between the provided left and right views. When making small sized autostereoscopic prints for lenticular viewing, experiments have shown that the demands for interpolation accuracy are relaxed compared to making very large prints. The lenticular prints consist of a hardcopy overcoated with a lenticular screen so that the stereoscopic image information can be viewed without eyewear. Alternatively, a raster barrier can be used, and as is well understood such barriers are optically interchangeable with lenticular screens. Moreover, the service bureau can provide the end user with interpolated interdigitated autostereo files that can be view on a home electronic display viewing device, such as the SynthaGram monitor offered by REAL D/StereoGraphics Corporation. Okoshi in “Three Dimensional Imaging Techniques”, NY Academic Press, 1976, discusses panoramagram and lenticular stereoscopic technology. The teachings of this Okoshi text are incorporated herein by reference.

Processes and procedures for turning two images into the foregoing, namely monochrome or color anaglyph prints, stereo pairs that can be viewed in a stereoscope, or a lenticular autostereoscopic print or files are known to those skilled in the art of stereoscopic print developing and production. By way of example, such processes are discussed in the above referenced Okoshi, and in “The World of 3-D” by Ferwerda, 3-D Book Productions, The Netherlands, 1990, “Stereo-Photography” by Linssen, The Fountain Press, London, 1952, and “Stereoscopic Photography” by Judge. Chapman & Hall, London, 1950. There is also good deal of information on producing anaglyphs available on the Internet.

In the second of the three branches following image capture, the files are handled directly by the user on his PC 207 and a hardcopy printer 208 is used to produce various kinds of prints. One choice is for conventional 2-D prints 209 using either one of the two images.

The other choices all involve producing stereoscopic hardcopy. The first choice is producing or printing an anaglyph print 210, which can be produced using an inkjet or other conventional color printing device or printer such as a dye-sublimation printer. With the proper software the left and right perspective views are turned into either color or monochrome anaglyphs and printed out, and can then be viewed with red-blue eyewear (one red lens and one blue lens).

Stereo pair hardcopy 211 can also be produced, in which left and right image pairs are placed side by side on a single card which can then be viewed in a Holmes-type stereoscope of well-known design. Finally, lenticular hardcopy prints 212 can be produced. The PC 207 is loaded with a software application that performs an interpolation and interdigitation process, as is well understood in the art, and lenticular prints are created using this software.

By way of example but not by way of limitation, the following disclosures pertain to computational algorithms that may be employed to create the intermediate images required for lenticular displays and hardcopy discussed herein: M. Agrawal and L. Davis, “Window-Based Discontinuity Preserving Stereo,” IEEE Conference on Computer Vision and Pattern Recognition (CVPR), 2004; S. Birchfield and C. Tomasi, “Depth Discontinuities by Pixel-to-Pixel Stereo,” IEEE International Conference on Computer Vision (ICCV), 1998; S. Birchfield and C. Tomasi, “Multiway Cut for Stereo and Motion with Slanted Surfaces,” ICCV, 1999; M. Bleyer and M. Gelautz, “Graph-Based Surface Reconstruction from Stereo Pairs Using Image Segmentation,” Proceedings of the SPIE, vol. 5665, January 2005; M. Bleyer and M. Gelautz, “A Layered Stereo Algorithm Using Image Segmentation and Global Visibility Constraints,” IEEE International Conference on Image Processing (ICIP), 2004, pp. 2997-3000; Y. Boykov, O. Veksler, and R. Zabih, “Fast Approximate Energy Minimization Via Graph Cuts,” IEEE Transactions on Pattern Analysis and Machine Intelligence (PAMI), v. 23, no. 11, 2001, pp. 1222-1239; and R. Brockers, M. Hund, and B. Mertsching, “A Fast Cost Relaxation Stereo Algorithm with Occlusion Detection for Mobile Robot Applications,” Proceedings of the Vision, Modeling, and Visualization Conference (VMV), 2004, pp. 47-53; R. Brockers, M. Hund, and B. Mertsching, “A Fast Cost Relaxation Stereo Algorithm with Occlusion Detection for Mobile Robot Applications,” Proceedings of the Vision, Modeling, and Visualization Conference (VMV), 2004, pp. 47-53; A. Criminisi, J. Shotton, A. Blake, C. Rother, and P. H. S. Torr, “Efficient Dense-Stereo and Novel-View Synthesis for Gaze Manipulation in One-to-One Teleconferencing,” Microsoft Research Technical Report MSR-TR-2003-59, September 2003; A. Criminisi, J. Shotton, A. Blake, C. Rother, and P. H. S. Torr, “Efficient Dense-Stereo with Occlusions and New View Synthesis by Four State DP for Gaze Correction,” submitted to the International Journal of Computer Vision (IJCV), 2005; Y. Deng, Q. Yang, X. Lin, and X. Tang, “A Symmetric Patch-Based Correspondence Model for Occlusion Handling,” ICCV, 2005; S. Forstmann, J. Ohya, Y. Kanou, A Schmitt, and S. Thuering, “Real-Time Stereo by Using Dynamic Programming,” CVPR Workshop on Real-Time 3D Sensors and Their Use, 2004; M. Gong and Y.-H. Yang, “Multi-Baseline Stereo Matching Using Genetic Algorithm,” CVPR Stereo Workshop, 2001; IJCV, 2002; M. Gong and Y.-H. Yang, “Near Real-Time Reliable Stereo Matching Using Programmable Graphics Hardware,” CVPR, 2005; J. Y. Goulermas and P. Liatsis, “A Collective-Based Adaptive Symbiotic Model for Surface Reconstruction in Area-Based Stereo,” IEEE Transactions on Evolutionary Computation, vol. 7 (5), pp. 482-502, 2003; H. Hirschmüller, “Improvements in Real-Time Correlation-Based Stereo Vision,” CVPR Stereo Workshop, 2001; IJCV, 2002; L. Hong and G. Chen, “Segment-Based Stereo Matching Using Graph Cuts,” CVPR, 2004; J. Jang, K. Lee, and S. Lee, “Stereo Matching Using Iterated Graph Cuts and Mean Shift Filtering,” Asian Conference on Computer Vision (ACCV), January 2006; C. Kim, K. J. Lee, B. T. Choi, and S. U. Lee, “A Dense Stereo Matching Using Two-Pass Dynamic Programming with Generalized Ground Control Points,” CVPR, 2005; V. Kolmogorov and R. Zabih, “Computing Visual Correspondence with Occlusions Using Graph Cuts,” ICCV, v. 2, 2001, pp. 508-515; V. Kolmogorov and R. Zabih, “Multi-Camera Scene Reconstruction Via Graph Cuts,” European Conference on Computer Vision (ECCV), May 2002; S. H. Lee, Y. Kanatsugu, and J.-I. Park, “Hierarchical Stochastic Diffusion for Disparity Estimation,” CVPR Stereo Workshop, 2001; IJCV, 2002; M. Lin and C. Tomasi, “Surfaces with Occlusions from Layered Stereo,” Ph.D. thesis, Stanford University, 2002; H. Mayer, “Analysis of Means to Improve Cooperative Disparity Estimation,” International Society for Photogrammetry and Remote Sensing (ISPRS), Conference on Photogrammetric Image Analysis, 2003; K. Mühlmann, D. Maier, J. Hesser, and R. Männer, “Calculating Dense Disparity Maps from Color Stereo Images, an Efficient Implementation,” CVPR Stereo Workshop, 2001; IJCV, 2002; S. Roy and I. J. Cox, “A Maximum-Flow Formulation of the N-Camera Stereo Correspondence Problem,” ICCV, 1998; D. Scharstein and R. Szeliski, “A Taxonomy and Evaluation of Dense Two-Frame Stereo Correspondence Algorithms,” IJCV, v. 47, no. 1-3, April-June 2002, pp. 7-42; Microsoft Research Technical Report MSR-TR-2001-81, November 2001; J. Shao, “Combination of Stereo, Motion and Rendering for 3D Footage Display,” CVPR Stereo Workshop, 2001; IJCV, 2002; C. Sun, “Fast Stereo Matching Using Rectangular Subregioning and 3D Maximum-Surface Techniques,” CVPR Stereo Workshop, 2001; IJCV, 2002; J. Sun, Y. Li, S. B. Kang, and H.-Y. Shum, “Symmetric Stereo Matching for Occlusion Handling,” CVPR, 2005; J. Sun, H. Y. Shum, and N. N. Zheng, “Stereo Matching Using Belief Propagation,” PAMI, v. 25, no. 7, July 2003, pp. 787-800; O. Veksler, “Fast Variable Window for Stereo Correspondence Using Integral Images,” CVPR, 2003; O. Veksler, “Stereo Correspondence by Dynamic Programming on a Tree,” CVPR, 2005; O. Veksler, “Stereo Matching by Compact Windows Via Minimum Ratio Cycle,” ICCV, v. 2, 2001, pp. 540-547; Y. Wei and L. Quan, “Region-Based Progressive Stereo Matching,” CVPR, 2004; K.-J. Yoon and I.-S. Kweon, “Locally Adaptive Support-Weight Approach for Visual Correspondence Search,” CVPR, 2005; C. L. Zitnick, S. B. Kang, M. Uyttendaele, S. Winder, and R. Szeliski, “High-Quality Video View Interpolation Using a Layered Representation,” ACM SIGGRAPH and ACM Transactions On Graphics, Vol. 23, Issue 3, pp. 600-608, August 2004. Again, various algorithms may be employed successfully in accordance with the teachings provided herein.

After the interpolation, by means of the above referenced citations or by other means, the print can be made directly onto paper and then viewed using a lens screen, or other viewing devices or arrangements can be employed. The lens screen can, for example, be a separate element in a holder with the hardcopy print slid into the holder.

In the third branch, the captured image can be viewed on a PC monitor 213. Either one of the left or right images can be viewed as a conventional 2-D print 214, or the left and right images can be viewed as a so-called micropolarizer print 216 using an appropriate monitor, i.e. a monitor that can properly display such prints. For example, an LCD TV can be equipped with Arisawa Manufacturing's XPol polarizing material and such a display device can be used to view a stereoscopic print. When viewing the files stereoscopically, the application loaded on the PC to display these image files can be configured for the particular selection device or monitor. A monitor that has interdigitated polarizer or retarder—as manufactured, for example, by Arisawa, known as Xpol, or sometimes known under the brand name Micropol by VRex, can cause the stereo pairs to be interdigitated or treated so that they are line-alternated or pixel-alternated to then be in intimate juxtaposition with the appropriate pixel elements. An early example of this spatially multiplexing or interdigitated technique using rows or columns of alternating polarization is described by Rehorn in “Stereoscopic Viewing Method and Apparatus” U.S. Pat. No. 2,631,496, which is incorporated herein by reference. A liquid crystal device of this type was first described by Lipton in “Polarel panel for stereoscopic displays”, in U.S. Pat. No. 5,686,975, which is also incorporated herein by reference.

Alternately, the left and right images can be time-multiplexed and viewed on an appropriate monitor 218, or projected using a field-sequential monitor. For example, the DLP engine that has been modified by Texas Instruments to allow for stereo pair viewing using diagonal interlace can be used in a front- or rear-projection application. In such a case the image can be viewed through shuttering eyewear such as eyewear sold under the brand name CrystalEyes® or by use of a polarization modulator such as the ZScreen®, available from REAL D/StereoGraphics Corporation.

In another application the image can be turned into what is called a SynthaGram image 217, which is the trade name of a product developed by StereoGraphics Corporation and marketed by REAL D, in which the image is first interpolated to produce intermediate views and then interdigitated. The result using a SynthaGram is a stereoscopic image that can be viewed without glasses. Various manufacturers produce such lenticular devices (or raster barrier monitors), any of which can be used for autostereoscopic viewing. Interpolating the intermediate views has been discussed above, including many references provided in the context of hardcopy printing. These references apply to the SynthaGram or similar electronic lenticular displays.

When producing the stereoscopic image from two images for display using a device such as a SynthaGram, interpolation can be omitted and the two images can be interdigitated. These two images can form the basis for a stereogram pair that can be viewed through a lenticular screen on a conventional desktop monitor. In this case a tradeoff has been made: the interdigitation of the two images is simple and does not require interpolation but the result is that the viewing zone or region for observing a good image is quite restricted. But such a limitation will not necessarily apply to handheld devices, such as cell phones, because the user can adjust the viewing angle for a handheld device instinctively to produce a comfortable viewing experience.

In the context of viewing the stereoscopic image on a PC monitor, a software application can be provided wherein the left and right images can be turned into a color or monochrome anaglyph 215, and such hardcopy can be viewed with red-green or red-blue eyewear. A special form of the anaglyph, the known under the trade name Infitec, can also be employed as the image selection technique. This process uses sharply defined regions of filtration rather than broad filtration in the visible spectrum to provide image selection.

As an alternative, a handheld viewing device such as a cell phone or a personal digital assistant can be used for viewing any of these image variants either in combination with and using a lenticular screen or, for example, by anaglyph or other means such as a head mounted display or selection device.

The present design therefore includes an infrastructure for producing stereoscopic snapshots or photos to be viewed as hardcopy, or on an electronic display screen using a variety of selection device technologies. By starting with stereo pairs, when properly processed, the images can be viewed either with the help of a service bureau, by means of a PC for producing hardcopy, or by direct viewing on a PC monitor.

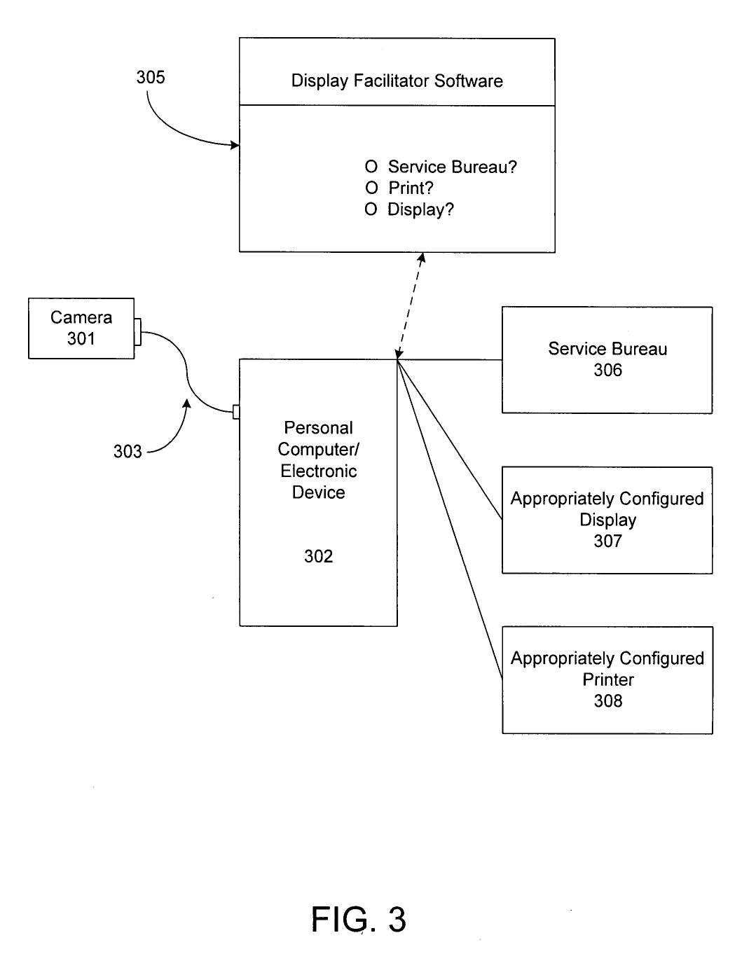

FIG. 3 illustrates one alternative for effectuating or realizing the design. Once the two digital images have been captured at the camera or cameras or camera setup 301, which refers to camera 101 of FIG. 1, they may be provided to a personal computer or other electronic device 302 via a connection, either wired as shown via wire 303 or wirelessly. The receiving device or camera(s) 301 may have transmitting capabilities and possibly processing capabilities such that the stereo pair of images may be processed and/or transmitted to a remote device. Once received by the PC or other electronic device 302, the user may be presented with a series of options via software such as software 305 or may simply save the files locally and/or transmit them to a third party or one of the devices suggested (such as printer 304). The software 305 may provide the user with a series of options as to how he wishes to receive or view the resultant stereoscopic images, including the aforementioned transmission to the service bureau 306, an appropriate configured display 307 for viewing, or to an appropriately configured printer 308. Such a software program facilitates distribution and display of the images received and their processing for display either via printing, service bureau, or electronic display. The device may provide the images to the service bureau via email, ftp transfer, or other reasonable and acceptable method, may employ secure delivery methods, and may process the images using software located on the PC as discussed above if display or hardcopy printing is desired. FIG. 3 illustrates the software program (not shown) facilitating display by passing information to either service bureau 306, printer 307, or display 308.

Alternately, the camera 301 may be physically taken to the service bureau, which may process the images from the camera 301 and provide the desired print or hardcopy. The camera 301 may provide for a memory stick (not shown) or digital card or other memory storage disk or device for purposes of removing the images and providing them to another device. Various computing devices, including but not limited to other PCs, wireless devices, servers, routers, and so forth may be used between the camera and the device or devices used to process and/or display the stereoscopic image. Thus the display facilitator may take various forms, such as a software program, a person physically facilitating distribution among the various display options, intermediate devices, or some other reasonable distribution and display arrangement for the digital images. The present design is not intended to be limiting in this regard but rather expansive in implementation possibilities.

Moreover the image may be outputted on an electronic display panel to serve as a framed picture of the type that is presently commercially available. Essentially these are devices for playing back image files, often playing back as a slide show, in a picture frame device incorporating a display panel and associated memory and electronics. In this case the preferred means would include a display screen overlaid with a lenticular sheet of the type described above with an image processed to produce the associated panoramagram image. The processed panoramagram files, interpolated from a stereo pair, can be produced by a service bureau as described above.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

The foregoing description of specific embodiments reveals the general nature of the disclosure sufficiently that others can, by applying current knowledge, readily modify and/or adapt the system and method for various applications without departing from the general concept. Therefore, such adaptations and modifications are within the meaning and range of equivalents of the disclosed embodiments. The phraseology or terminology employed herein is for the purpose of description and not of limitation.

What is claimed is:

1. A method for enabling viewing of stereoscopic images, comprising:
generating a stereo pair of images in digital form using at least one image recording device configured to produce two digital images producing a stereo pair; and
offering the user an ability to provide the stereo pair of images to a display facilitator, the display facilitator comprising an ability to elect display from at least one from a group comprising a service bureau, a device configured to print the stereoscopic image, and a device configured to display the stereoscopic image;
wherein the user has an ability to choose a display facilitator for receiving the stereoscopic image and further has an ability to view at least one stereoscopic image resulting from said generating.

2. The method of claim 1, wherein the display facilitator comprises software configured on a computing device.

3. The method of claim 1, wherein the image recording device comprises a camera having two offset lenses.

4. The method of claim 1, wherein the display facilitator electing to display from a device configured to display the stereoscopic image enables displaying the stereoscopic image in at least one display mode selected from a group comprising:
a two dimensional display;
display of an anaglyph;
a Micropol type display;
display using a SynthaGram type device; and
time multiplexed images shown on a display.

5. The method of claim 1, wherein the service bureau comprises a third party having an ability to print the stereoscopic image in at least one format selected from a group comprising:
two dimensional prints;
anaglyph prints;
stereoscope prints;
lenticular files; and
lenticular prints.

6. The method of claim 1, wherein the display facilitator electing to display by printing the stereoscopic image enables printing the stereoscopic image in at least one format selected from a group comprising:
a two dimensional print;
an anaglyph print;
a stereoscope print; and
a print clearly viewable using a lenticular array.

7. The method of claim 1, wherein the at least one image recording device comprises multiple photographic devices capable of photographing an object from different perspectives simultaneously.

8. The method of claim 1, wherein the display facilitator comprises a person electing from various display options.

9. A method of obtaining stereoscopic images and viewing the stereoscopic images in a desired format, comprising:
obtaining a stereo pair of images at an optical receiving device, said optical receiving device configured to convert images received into at least one digital representation of the stereo pair; and
using a display facilitator to direct distribution of the at least one digital representation of the stereo pair to at least one of:
a service bureau;
a device for configured to print the stereoscopic image; and
a device configured to display the stereoscopic image;
wherein the display facilitator directs the at least one digital representation of the stereo pair to an entity enabling a user to view the stereoscopic image in a desired format.

10. The method of claim 9, wherein the display facilitator comprises software configured on a computing device.

11. The method of claim 9, wherein the optical receiving device comprises a camera having two offset lenses.

12. The method of claim 9, wherein the display facilitator directing the stereoscopic image to a display enables displaying the stereoscopic image in at least one display mode selected from a group comprising:
a two dimensional display;
display of an anaglyph;
a Micropol type display;
display using a SynthaGram type device; and
time multiplexed images shown on a display.

13. The method of claim 9, wherein the service bureau comprises a third party having an ability to print the stereoscopic image in at least one format selected from a group comprising:
two dimensional prints;
anaglyph prints;
stereoscope prints;
lenticular files; and
lenticular prints.

14. The method of claim 9, wherein the display facilitator electing to display by printing the stereoscopic image enables printing the stereoscopic image in at least one format selected from a group comprising:
a two dimensional print;
an anaglyph print;
a stereoscope print; and
a print clearly viewable using a lenticular array.

15. The method of claim 9, wherein the at least one image recording device comprises multiple photographic devices capable of photographing an object from different perspectives simultaneously.

16. The method of claim 9, wherein the display facilitator comprises a person electing from various display options.

17. A method for providing a stereoscopic image to a user in a desired format, comprising:
receiving a stereo image pair at a device and providing the stereo pair to a display facilitator as at least one digital representation of the stereo pair; and
facilitating display of the at least one digital representation of the stereo pair by directing distribution of the at least one digital representation of the stereo pair to at least one of:
a service bureau;
a device for configured to print the stereoscopic image; and
a device configured to display the stereoscopic image.

18. The method of claim 17, wherein the display facilitator comprises software configured on a computing device.

19. The method of claim 17, wherein the optical receiving device comprises a camera having two offset lenses.

20. The method of claim 17, wherein the service bureau comprises a third party having an ability to print the stereoscopic image.
